(19) United States
(12) Patent Application Publication
(10) Pub. No.: US 2013/0205035 A1
(43) Pub. Date: Aug. 8, 2013

(54) METHOD AND DEVICE FOR NETWORK COMMUNICATIONS

(71) Applicant: Gang Chen, Beijing (CN)

(72) Inventor: Gang Chen, Beijing (CN)

(73) Assignee: CHINA MOBILE COMMUNICATIONS CORPORATION, Beijing (CN)

(21) Appl. No.: 13/812,012

(22) PCT Filed: Jul. 25, 2011
(86) PCT No.: PCT/CN2011/077541

§ 371 Date: Apr. 3, 2013

(30) Foreign Application Priority Data
Jul. 28, 2010 (CN) 201010239857.0

(51) Int. Cl. H04L 29/12

(52) U.S. Cl. CPC H04L 61/251
USPC 709/230

(57) ABSTRACT

The present invention provides a method and a device for network communication. The method comprises the steps of translating, by a terminal, IPv6 information into IPv4 information when receiving the IPv6 information from an IPv6 application, and transmitting an IPv6 application request carrying the IPv4 information; and receiving, by the terminal, an IPv6 application response corresponding to the IPv6 application request. The present invention enables free communication between IPv6 applications and services of the other IP address families within an IPv4 network.

The present application claims the priority of the Chinese patent application No. 201010239857.0 filed on Jul. 28, 2010 and entitled “method and device for network communication”, which is incorporated herein by reference.

### TECHNICAL FIELD

The present invention relates to the field of communication technology, in particular to a method and a device for network communication.

### BACKGROUND

Along with the running out of global IPv4 (Internet Protocol version 4) addresses and the “always-online” requirement of services on terminals, the deployment of IPv6 (Internet Protocol version 6) technology will become inevitable.

In order to achieve the deployment and smooth transition of IPv6 technology, it is necessary to set the introduction strategy and the application scenarios of IPv6 technology. To introduce a concept of IPv6 network gradually, it will be the first step for the deployment of IPv6 technology to build an IPv6 network and an IPv4/IPv6 dual-stack network.

To be specific, with regard to the evolution of IPv6 technology, IETF (The Internet Engineering Task Force) has undertaken a series of feasible theoretical predictions, and pointed out that the evolution of IPv6 technology mainly includes the following three stages.

Stage 1: an initial stage of the IPv6 evolution, in which most of the services in a network are still provided based on IPv4 and various IPv6 transition technologies (such as tunneling, translating and dual-stack technology) are gradually implemented in the network so as to achieve the transition from IPv4 to IPv6, with the relevant traffics of IPv6 being gradually increased in the network.

Stage 2: a coexisting stage of IPv4 and IPv6, in which an Internet service provider will provide users with both IPv4 and IPv6 services simultaneously, and the user may judge and select the desired type of services in accordance with the specific situations. In addition, in this stage, the deployment of IPv6 will keep increasing gradually, and IPv6 will have the service resources as rich as IPv4.

Stage 3: a late stage of the IPv6 evolution, in which the services in the network are mainly provided on the basis of IPv6, and the IPv4 services will be reduced gradually. IPv6 network will become a main networking technology for the Internet, and the range of IPv4 network will shrink. As a result, the transition from IPv4 to IPv6 will be accomplished.

It can be seen that, it will be a mainstream way of providing IPv6 services for the future Internet. In the mid-to-late of the IPv4 to IPv6 transition, along with the occurrence of IPv6-only network, the Internet will mainly provide the applications that merely support IPv6 technology. In this case, although IPv4 network will be gradually replaced by IPv6 network, it still needs a long period of time for the IPv4 technologies and networks to disappear due to the old devices that do not support IPv6 and the fact that some operators do not support IPv6 applications for the cost to upgrade IPv4 network to IPv6 network.

As a result, it needs to enable IPv6 applications to operate and work in an IPv4 network. However, the solutions provided in the prior art cannot achieve the communication of IPv6 applications through an IPv4 network in a good manner.

SUMMARY

The present invention provides a method and a device for network communication, so as to achieve the communication of IPv6 applications through an IPv4 network.

To achieve the above-mentioned purpose, the present invention provides a method for network communication, comprising the steps of:

translating, by a terminal, IPv6 information into IPv4 information when receiving the IPv6 information from an IPv6 application, and transmitting an IPv6 application request carrying the IPv4 information; and

receiving, by the terminal, an IPv6 application response corresponding to the IPv6 application request.

The present invention provides a method for network communication, comprising the steps of:

receiving, by the terminal, IPv6 application information, transmitting the IPv6 application information to a dual-stack server, and receiving service data corresponding to the IPv6 application information returned from the dual-stack server.

The present invention further provides a device for network communication, comprising:

a translating module configured to translate IPv6 information into IPv4 information when receiving the IPv6 information from an IPv6 application;

a transmitting module configured to transmit an IPv6 application request carrying the IPv4 information; and

a receiving module configured to receive an IPv6 application response corresponding to the IPv6 application request.

The present invention further provides a gateway equipment, comprising:

a first receiving module configured to receive a translated IPv4 request from a terminal;

a first transmitting module configured to transmit an IPv6 request corresponding to the IPv4 request information to a device in an IPv6 network;

a second receiving module configured to receive an IPv6 response from the device in the IPv6 network with respect to the IPv6 request corresponding to the IPv4 request information; and

a second transmitting module configured to transmit an IPv4 response corresponding to the IPv6 response to a device in an IPv4 network.

The present invention further provides a device for network communication, comprising:

a transmitting module configured to transmit IPv6 application information to a dual-stack server when receiving the IPv6 application information; and

a receiving module configured to receive service data corresponding to the IPv6 application information from the dual-stack server.

The present invention, as compared to the prior art, at least has an advantage of achieving free communication between IPv6 applications and the services of the other IP address families in an IPv4 network.

### BRIEF DESCRIPTION OF THE DRAWINGS

In order to make the technical solutions according to the embodiments of the present invention or the prior art more apparent, the drawings to be used in the embodiments or the prior art will be described hereinafter. Obviously, these drawings merely relate to some of the embodiments of the present invention and a person skilled in the art, without any creative effort, may obtain the others in accordance with these drawings.

FIG. 1 is a flow chart of a method for network communication according to the first embodiment of the present invention;

FIG. 2 is a schematic view showing a system architecture in an application scenario according to embodiments of the present invention;

FIG. 3 is a flow chart where an IPv6 application accesses an IPv6 server according to the second embodiment of the present invention;

FIG. 4 is a flow chart where an IPv6 application accesses an IPv4 server according to the third embodiment of the present invention;

FIG. 5 is a flow chart where an IPv6 application accesses a dual-stack server according to the fourth embodiment of the present invention; and

FIGS. 6-8 are schematic views showing a device for network communication according to embodiments of the present invention.

### DETAILED DESCRIPTION

It still needs a long period of time for the IPv4 technology and network to disappear, while IPv6 applications are developing rapidly. Thus, it needs to enable the IPv6 applications to operate and work in an IPv4 network. In addition, there still exists in the mobile network operation a need to perform the communication of IPv6 applications via an IPv4 network.

Prior to R8, it is impossible for a terminal in a mobile network to obtain both an IPv4 address and an IPv6 address at a PDP (Packet Data Protocol) context, and two PDP contexts shall be activated so as to deliver the IPv4 address and the IPv6 address respectively.

There are a large number of mobile terminals in a mobile network prior to R8. In order to save the mobile network resources, the terminal may only activate a PDP context once before communication, i.e., the terminal merely obtains one address, usually an IPv4 address. When the terminal initiates a service request to IPv6, the applications of different address families cannot communicate with each other, so the terminal is forced to activate another PDP context to meet the requirements of IPv6 communication. At this time, if a function for achieving the communication of IPv6 applications via an IPv4 network is used, the communication needs for the terminal will be met merely by maintaining the PDP context once.

Given all these considerations, it is an important issue during the transition from IPv4 to IPv6 to access the IPv6 applications and to achieve the communication at an application layer in an IPv4 network. For this issue, solutions may be adopted, i.e., solutions based on a terminal side and solutions based on a network side.

In the solutions based on a terminal side, Teredo may enable a node located behind NAT (Network Address Translation) to obtain a global IPv6 connection. Its core idea is packaging an IPv6 packet in a payload of an IPv4 UDP (User Datagram Protocol) packet, so as to pass through an NAT device. During the deployment of Teredo, it needs assistance from a Teredo server and a Teredo relay.

In the solutions based on a network side, mainly the technologies such as 6to4 and 6over4 are used. The 6to4 tunneling technology enables the communication between an isolated IPv6 site and the other isolated sites or the sites in an IPv6 backbone network when no IPv6 Internet service is provided by an Internet service provider.

The 6to4 transition technology adopts a mechanism of constructing a tunnel automatically, and it requires a site to use a special IPv6 address (2002:IPv4ADDR::/48). This IPv6 address is automatically derived from the IPv4 address of the site, so each node adopting the 6to4 mechanism must at least include a globally unique IPv4 address.

Such a mechanism enables the IPv4 address at a tunnel endpoint to be extracted from the IPv6 address, so the tunnel is constructed automatically. A 6to4 router of a receiver may automatically differentiate whether a tunnel receiving endpoint is within the domain. No new entry will be introduced into an IPv4 routing table when the 6to4 transition technology is adopted.

In addition, the 6over4 technology solves the similar issue as the 6to4 technology, but it is implemented in a different manner. The 6over4 technology adopts a mechanism where an IPv4 multicast automatically constructs a tunnel. The 6over4 tunnel, via the multicast mechanism, connects IPv6 hosts, which are inside a network but on different subnets and are not directly connected to an IPv6 router, to a virtual link, thereby to form the same subnet logically. Its core idea is mapping an IPv6 multicast address into an IPv4 multicast address, and accomplishing the discovery of the IPv4 address of the other IPv6 hosts and the discovery of an IPv4 border router through the router solicitation/advertisement and neighbor solicitation/advertisement procedures in the neighbor discovery.

For IPv6, the whole IPv4 multicast domain is a virtual Ethernet. The 6over4 transition technology differs from the 6to4 tunneling technology in that the 6over4 transition technology does not require an IPv6 address of a special format. The IPv4 multicast domain may be a network of a globally unique IPv4 address, or a part of a private IPv4 network. The IPv6 may be independent of an underlying link and across an IPv4 subnet.

However, a premise of using such a mechanism as 6over4 is that the IPv4 network infrastructure must support IPv4 multicasting. Such a mechanism is adapted to an isolated IPv6 host on a physical link to which an IPv6 router is not directly connected, and as a result the IPv6 host can use the IPv4 multicast domain as a virtual link, thereby becomes a full-featured IPv6 site.

It is to be noted that, during the implementation of Teredo, the Teredo mechanism embeds an IPv4 mapping address and a port into the address, and the special address prefix destroys the hierarchical routing system of IPv6, thereby the relevant issues of IPv6 in routing scalability will occur. In addition, during the implementation of Teredo, it needs support from a Teredo delay and a Teredo server, and all of the packets that intend to access the IPv6 applications need to be processed on the Teredo server, so the data routing in Teredo is never optimal. The load of the Teredo server will increase gradually along with the increase of Teredo users, and this further leads to a series of security problems. In addition, Teredo cannot traverse a symmetric NAT and thus cannot work in the relevant NAT scenarios.

The 6to4 technology is usually implemented in a border router, so it is required that the border router must support the 6to4 technology. During the implementation of the 6to4 technology, once an IPv4 address changes, it needs to reallocate the IP addresses of the entire site. As a result, it cannot be adapted to a dynamic address configuration situation, e.g., dial-up access, xDSL (Digital Subscriber line) access, DHCP (Dynamic Host Configuration Protocol), etc. In addition, there also exists a problem of single point failure in the 6to4 technology. If a border 6to4 router fails, the communication between the entire site and the other IPv6 will be interrupted.

For the 6over4 technology, the 6over4 tunneling is adapted to communication between hosts having dual protocol stack. A virtual link is created by means of the IPv4 multicast mechanism, so the execution of the 6over4 mechanism requires that the network must support a multicasting technology. However, due to the lack of IPv4 networks that support multicast and less advantage of the 6over4 technology over the 6to4 technology, the 6over4 technology is seldom used in practice.

In addition, the above-mentioned technologies are both tunneling technologies, so they also share the common disadvantages thereof. Firstly, during the transition from IPv4 to IPv6, the IP header will be increased to 60 bytes due to the tunneling technology. For a mobile network operator, wireless air interfaces are valuable and scarce resources, and hundreds of millions of mobile terminals will increase the network traffic load considerably. Moreover, the tunneling technology must be set up and maintained prior to the data communication, so it is expensive. Secondly, there exist in the above-mentioned solutions the problems of network single-point failures and bottlenecks. For example, the Teredo communication data needs to be processed by a Teredo server, and the 6to4 solutions requires a specific 6to4 router. Thirdly, since the tunneling technology uses a multilayer data packaging header, the data header carrying QoS (Quality of Service) control information is usually packaged in another IP packet, and the device cannot identify the QoS information at the QoS policy enforcement point.

With respect to the above-mentioned problems, the present invention provides a method and a device for network communication, so as to achieve communication of an IPv6 application via an IPv4 network, meet the requirements of free communication between IPv6 applications and IPv4 applications, overcome the adverse effects of a tunneling mechanism on air interface resources, prevent the consumption of additional air interface resources, support direct communication between the hosts, prevent the problems of network single-point failures and bottlenecks, and support an access request initiated by an IPv4 host to IPv6.

The technical solutions according to the embodiments of the present invention will be described in a clear and complete manner in conjunction with the drawings. Obviously, the embodiments described hereinafter are merely a part, but not all, of the embodiments. Based on these embodiments, a person skilled in the art may obtain the other embodiments without any creative effort, all of which fall within the scope of the present invention.

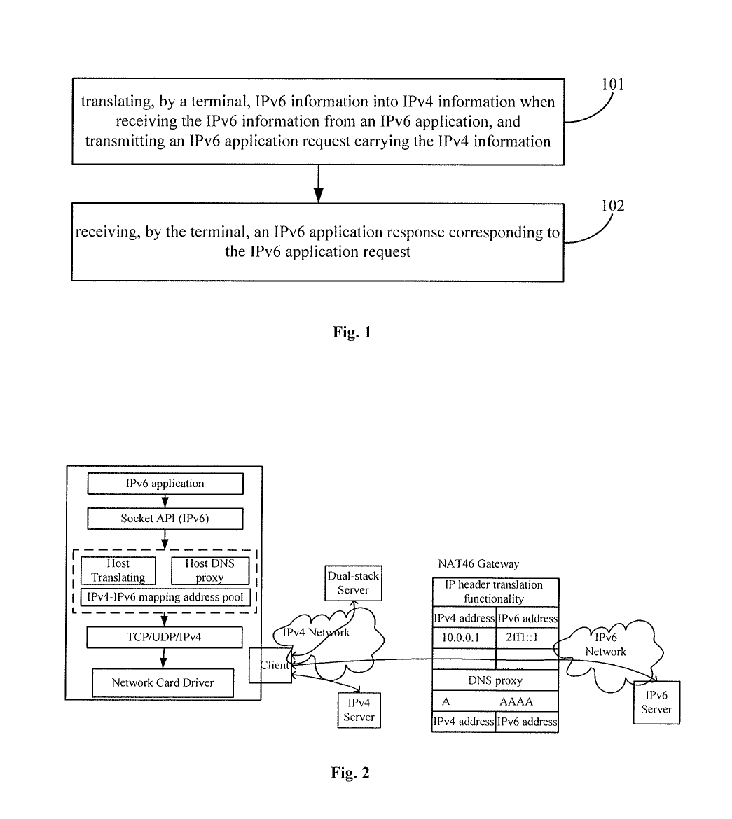

As shown in FIG. 1, the first embodiment of the present invention provides a method for network communication, which comprises the steps of:

Step 101: translating, by a terminal, IPv6 information into IPv4 information when receiving the IPv6 information from an IPv6 application, and transmitting an IPv6 application request carrying the IPv4 information; and

Step 102: receiving, by the terminal, an IPv6 application response corresponding to the IPv6 application request.

It can be seen that, the solution provided by the embodiment of the present invention can be used to achieve free communication in an IPv4 network between IPv6 applications and the services of the other IP address families.

In order to make the solution more clear, the embodiment of the present invention is described hereinafter in conjunction with a specific application scenario, where the system architecture as shown in FIG. 2 is taken as an example.

In this application scenario, in order to achieve the communication of an IPv6 application via an IPv4 network, an IPv4 terminal (such as an IPv4 host) will be provided with relevant functions to process packets of the IPv6 application (of course, it is merely necessary that the IPv6 application is located within the IPv4 network, but not limited to be located in the IPv4 terminal in a practical application), and to perform corresponding processings on domain messages, so as to achieve free communication between the IPv6 application and an IPv4 server, a dual-stack server or an IPv6 server in the network.

To be specific, in order to achieve the communication between the IPv6 application and an IPv6 server, it is required to provide an NAT46 gateway on a boundary of an IPv4 network and an IPv6 network (this NAT46 gateway may be a single device, or the relevant functions thereof are integrated into an existing device, while a single device is taken as an example in the present invention) for the relevant processing of the packets.

In this application scenario, the modules to be added on an IPv4 terminal include, but not limited to, a host translating module, a host DNS (Domain Name System) proxy module, and an IPv4-IPv6 mapping address pool functional module. Of course, in a practical application, these modules may be combined or further divided into submodules. Here, the above three functional modules are taken as an example in this application scenario.

(1) The host translating module, configured to complete the conversion from IPv6 data generated by an IPv6 application to IPv4 data.

To be specific, when the host translating module receives information from the IPv6 application, it needs to translate the application information including an IPv6 address into IPv4 application information, and transmit the information in an IPv4 network.

In this application scenario, the functions of the host translating module may be executed based on Header translation and Socket translation. The execution of Header translation includes the steps of monitoring IPv6 packets from the IPv6 application and converting a packet header into IPv4. The execution of Socket translation mainly includes the steps of intercepting an IPv6 system call initiated by the IPv6 application and converting it into a corresponding IPv4 system call so as to complete the transmission of IPv4 packets. Based on the above two processing mechanisms, the host translating module may translate a source address and a target address from IPv6 to IPv4.

(2) The host DNS proxy module, configured to process a DNS request carrying an AAAA type from IPv6. In order to meet the requirement of free communication between the IPv6 application and a correspondent-node server, the following operations need to be executed by the host DNS proxy module.

When the IPv6 application initiates a DNS request carrying an AAAA type, the host DNS proxy module translates the AAAA type into an AAAA type and an A type, and transmits a DNS request carrying an AAAA type and an A type to a network.

When the correspondent node accessed by the IPv6 application is a dual-stack server, the host DNS proxy module receives a DNS response carrying an A type and an AAAA type from a DNS server, and returns the DNS response carrying an AAAA type to the upper layer IPv6 application.

When the correspondent node accessed by the IPv6 application is an IPv4 server, the host DNS proxy module receives a DNS response carrying an A type from the DNS server, creates a mapping record in a mapping pool of IPv4 and IPv6 of the terminal, translates the record of an A type into a record of an A type and an AAAA type, and returns the DNS response carrying the translated AAAA type to the upper layer IPv6 application.

When the correspondent node accessed by the IPv6 application is an IPv6 server, the host DNS proxy module receives a DNS response carrying an AAAA type from the DNS server, initiates a DNS request carrying an A type and an AAAA type again to an NAT46 gateway, and waits for a DNS response carrying an A type and an AAAA type from the NAT46 gateway.

It is to be noted that, with respect to the applications that initiate DNS request classes, the record of an A (a mnemonic symbol) type needs to be processed by the DNS server in an IPv4 network environment when it performs forward resolution, while the record of an AAAA (a mnemonic symbol) type needs to be processed by the DNS server in an IPv6 network environment when it performs forward resolution. In a network environment where IPv6 and IPv4 coexist, the records of an A type and an AAAA type need to be processed when it performs forward resolution. The record of an A type maps a target name corresponding to an IPv4 address, which includes host name, time-to-live (TTL) and IPv4 address. The record of an AAAA type maps a target name corresponding to an IPv6 address, which includes host name, TTL and IPv6 address.

(3) The IPv4-IPv6 mapping address pool functional module, configured to create IPv4 and IPv6 records on a host, and assist the host DNS proxy functionality to create a DNS response carrying an A type and an AAAA type and return it to the IPv6 application in a scenario where an IPv6 application accesses an IPv4 server.

In this application scenario, in order to achieve interaction between the IPv6 application and a server in a remote IPv6 network, it is necessary to use the processing functionality of the NAT46 gateway to complete the translation of data information. The modules to be added to the NAT46 gateway include, but not limited to, IP header translation, a DNS gateway proxy, and an IPv4-IPv6 mapping address pool. Of course, in a practical application, these functional modules may be combined or further divided into submodules. The above three functional modules are taken as an example in this application scenario.

(1) The IP header translation is configured to translate a source address and a target address of a packet to be transmitted to the NAT46 gateway from IPv4 to IPv6.

To be specific, the NAT46 gateway, when processing the packet, checks the target address of the packet, and translates IPv4 into IPv6 when the packet falls within the range of mapping addresses to be maintained by the NAT46 gateway. Otherwise, it directly forwards the packet and merely supports a routing function.

(2) The DNS gateway proxy is configured to execute the processing of a DNS request initiated toward the NAT46 gateway. When the NAT46 gateway receives the DNS request transmitted thereto, it forwards requests of an AAAA type and an A type to an IPv6 network, and waits for a response.

When receiving a request of an AAAA type, the NAT46 gateway needs to create a mapping record from IPv6 to IPv4 in the gateway. The IPv4 address is a dedicated IPv4 shared address reserved in the network for the NAT46 gateway.

In this application scenario, for the purpose of saving IPv4 addresses, the mapping may be performed in a port-multiplexing manner, i.e., one reserved IPv4 shared address represents 65535 IPv6 addresses. A network manager may manage the reserved IPv4 addresses in accordance with the network capacity.

To be specific, the DNS gateway proxy functionality needs to resolve an AAAA type to an AAAA type and an A type in accordance with the reservation information, reserve the mapping information on the NAT46 gateway, and return an A type and an AAAA type to a host which requires the address resolution.

(3) The IPv4-IPv6 mapping address pool is mainly configured to maintain the mapping information created by the DNS.

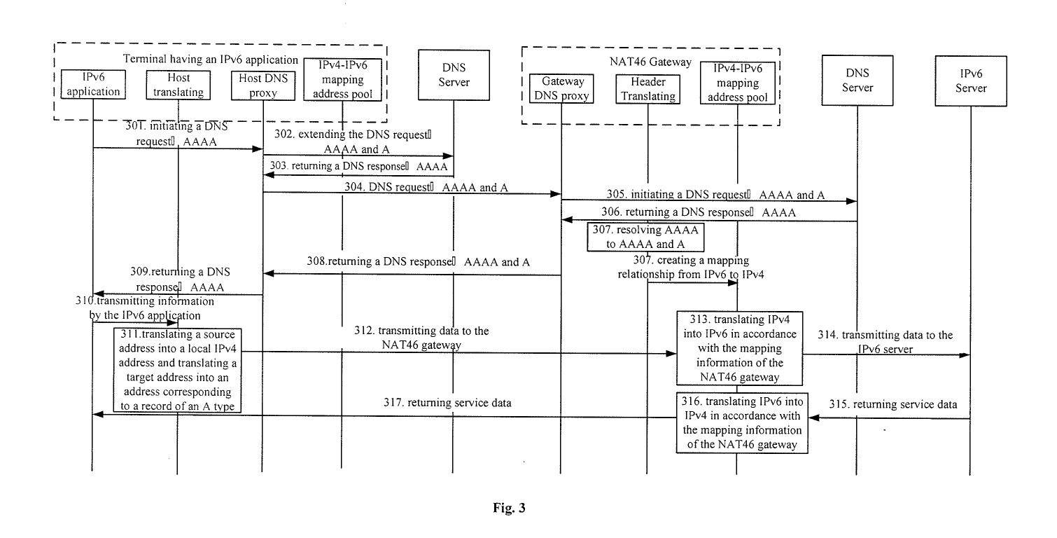

According to the second embodiment of the present invention, in this application scenario, the function flow where an IPv6 application accesses an IPv6 server is shown in FIG. 3, which comprises the following steps.

Step 301: the IPv6 application initiates DNS request information. The DNS request information is based on an AAAA type, wherein prior to being transmitted to an IPv4 network, the DNS request information is acquired by a host DNS proxy module of a terminal.

Step 302: the host DNS proxy module extends the IPv6 DNS request information of an AAAA type, and transmits a DNS request carrying an A type and an AAAA type to a DNS server, wherein the DNS server is a DNS server within the IPv4 network.

Step 303: the DNS server returns a DNS response carrying an AAAA type to the host DNS proxy module. The correspondent node accessed by the IPv6 application is an IPv6 server, thus the DNS server needs to return the DNS response carrying an AAAA type to the host DNS proxy module.

Step 304: the host DNS proxy module initiates a DNS request carrying an AAAA type and an A type again to the NAT46 gateway. To be specific, when the host DNS proxy module determines that merely an AAAA type is received, it needs to initiates a DNS request carrying an AAAA type and an A type again to the NAT46 gateway.

Step 305: the NAT46 gateway transmits DNS request information carrying an AAAA type and an A type to a DNS server within an IPv6 network. To be specific, when the NAT46 gateway receives the DNS request information transmitted thereto, it needs to transmit the DNS request information to the DNS server within the IPv6 network.

Step 306: the DNS server returns a DNS response carrying an AAAA type to the NAT46 gateway. To be specific, when receiving the DNS request information, the DNS server within the IPv6 network needs to return the DNS response carrying an AAAA type to the NAT46 gateway.

Step 307: the NAT46 gateway resolves the AAAA type to an A type and an AAAA type, and creates a mapping relationship from IPv6 to IPv4. To be specific, when receiving the DNS response carrying an AAAA type, the gateway DNS proxy in the NAT46 gateway needs to resolve the AAAA type to an A type and an AAAA type, and create a mapping address record from IPv6 to IPv4 on the NAT46 gateway. In addition, in order to save the IPv4 address pool resources maintained by the NAT46 gateway, the mapping address record from IPv6 to IPv4 may be implemented in a port-multiplexing manner.

Step 308: the gateway DNS proxy in the NAT46 gateway returns the resolved A type and AAAA type to the host DNS proxy module in the host.

Step 309: the host DNS proxy module returns the AAAA type to the IPv6 application.

Step 310: the IPv6 application initiates an application request toward the network. To be specific, in the application request initiated toward the network, the source address adopted by the IPv6 application is a fake address of the own parameters of a terminal. This address is merely used in the terminal and will not bring any influence on the network.

Step 311: the host translating module monitors and intercepts the application request information initiated by IPv6, and translates the source address and the target address from IPv6 to IPv4. With respect to the source address, it needs to translate the IPv6 fake address into an IPv4 address configured for the host, and with respect to the target address, it needs to translate the IPv6 target address into an IPv4 address corresponding to the record of an A type.

Step 312: the host translating module transmits the translated data to the NAT46 gateway.

Step 313: the NAT46 gateway translates the IPv4 address into an IPv6 address according to the information of the IPv4-IPv6 mapping address pool. To be specific, the NAT46 gateway needs to translate a source IPv4 address and a target IPv4 address into IPv6 addresses. With respect to the source address, a special IPv6 prefix, which falls within the range of NSP, will be configured on the NAT46 gateway. The source IPv4 address and the NSP prefix are combined to form the source IPv6 address. With respect to the target address, the NAT46 gateway translates the IPv4 address into the IPv6 address in accordance with the information of the IPv4-IPv6 mapping address pool.

Step 314: the NAT46 gateway transmits the translated data to an IPv6 server.

Step 315: the IPv6 server returns corresponding service data to the NAT46 gateway.

Step 316: after receiving the service data, the NAT46 gateway translates the IPv6 address into an IPv4 address. In this step, it needs to perform corresponding processings in accordance with an inverse process of step 313. To be specific, with respect to the source address, the NAT46 gateway needs to remove the special IPv6 prefix within the range of NSP from the IPv6 address, and with respect to the target address, the NAT46 gateway translates the IPv6 address to the IPv4 address in accordance with the information of the IPv4-IPv6 mapping address pool.

Step 317: the NAT46 gateway transmits the translated service data to the host, and the whole service interaction is completed after the host receives the data from the NAT46 gateway.

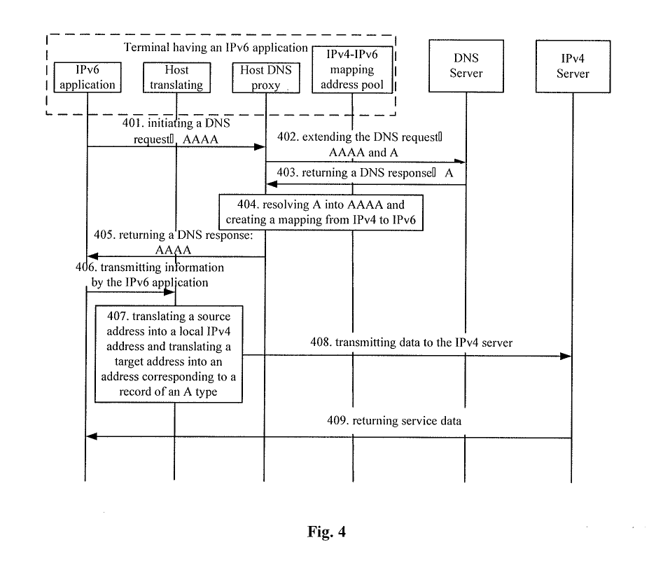

According to the third embodiment of the present invention, the function flow where an IPv6 application accesses an IPv4 server is shown in FIG. 4, which comprises the following steps.

Step 401: the IPv6 application initiates DNS request information. The DNS request information is based on an AAAA type, wherein prior to being transmitted to an IPv4 network, the DNS request information is acquired by a host DNS proxy module of a terminal.

Step 402: the host DNS proxy module extends the IPv6 DNS request information of an AAAA type, and transmits DNS requests carrying an A type and an AAAA type to a DNS server, wherein the DNS server is a DNS server within the IPv4 network.

Step 403: the DNS server returns a DNS response carrying an A type to the host DNS proxy module. The correspondent node accessed by the IPv6 application is an IPv4 server, thus the DNS server needs to return the DNS response carrying an A type to the host DNS proxy module.

Step 404: the host DNS proxy module resolves the A type to an AAAA type, and creates a mapping relationship from IPv4 to IPv6. To be specific, when receiving the DNS response carrying an A type, the host DNS proxy module needs to resolve the A type to an AAAA type so as to enable the upper layer IPv6 application to identify the DNS response information, and create a mapping record from IPv4 to IPv6 in the IPv4-IPv6 mapping address pool of the host. In the mapping address pool, the host maintains the IPv6 address and maps it to IPv4. In order to avoid address conflict with an external IPv6 correspondent node, the IPv6 address pool falls within the range of ::8/. The addresses within this range have been reserved by IETF and will not appear on the network. As a result, the address conflict will not occur.

Step 405: the host DNS proxy module returns the resolved AAAA type to the IPv6 application.

Step 406: the IPv6 application initiates an application request toward the network. In the application request initiated toward the network, the source address adopted by the IPv6 application is a fake address of the own parameters of the host. This address is merely used in the host and will not bring any influence on the network. The target address adopted by the IPv6 application is an address generated from the host IPv6 address pool.

Step 407: the host translating module translates the IPv6 address to an IPv4 address. To be specific, the host translating module monitors and intercepts the application request information initiated by IPv6, and translates the source address and the target address from IPv6 into IPv4. With respect to the source address, it needs to translate an IPv6 fake address into an IPv4 address configured for the host, and with respect to the target address, it needs to translate the target IPv6 address into an IPv4 address corresponding to the record of an A type.

Step 408: the host translating module transmits the translated data to an IPv4 server.

Step 409: after receiving the application request information, the IPv4 server returns service data, and the whole service interaction is completed after the host receives the data from the server.

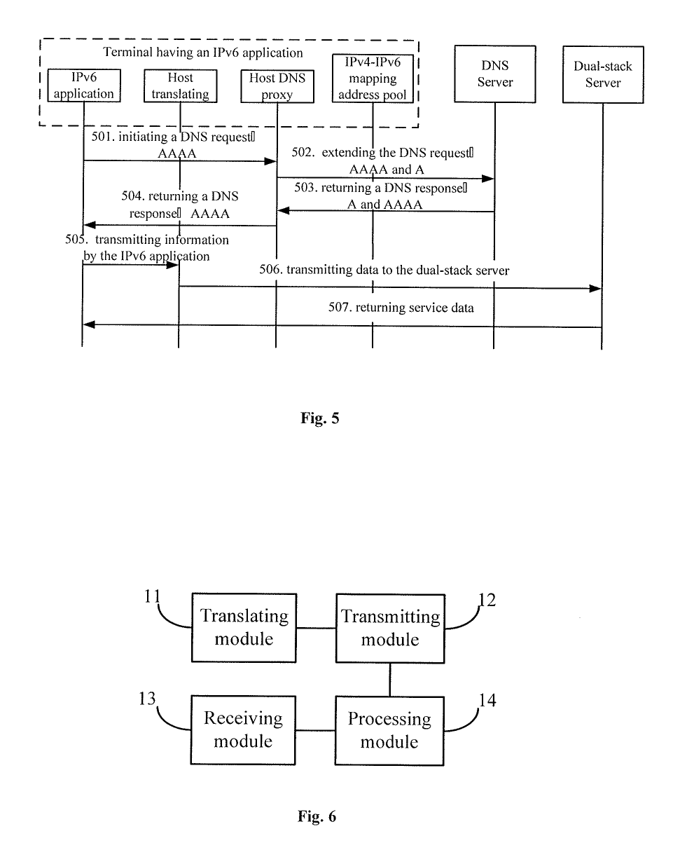

According to the fourth embodiment of the present invention, the function flow where an IPv6 application accesses a dual-stack server is shown in FIG. 5, which comprises the following steps.

Step 501: the IPv6 application initiates DNS request information. The DNS request information is based on an AAAA type, wherein prior to being transmitted to an IPv4 network, the DNS request information is acquired by a host DNS proxy module of a terminal.

Step 502: the host DNS proxy module extends the IPv6 DNS request information of an AAAA type, and transmits a DNS request carrying an A type and an AAAA type to a DNS server, wherein the DNS server is a DNS server within the IPv4 network.

Step 503: the DNS server returns a DNS response carrying an A type and an AAAA type to the host DNS proxy module. The correspondent node accessed by the IPv6 application is a dual-stack server, thus the DNS server needs to return the DNS response carrying an A type and an AAAA type to the host DNS proxy module.

Step 504: the host DNS proxy module returns the AAAA type to the IPv6 application.

Step 505: the IPv6 application initiates an application request toward the network. In the application request initiated toward the network, the source address adopted by the IPv6 application is a fake address of the own parameters of the host. This address is merely used in the host and will not bring any influence on the network. The target address adopted by the IPv6 application is an IPv6 address corresponding to the AAAA type.

Step 506: the host translating module transmits the IPv6 application to a dual-stack server.

Step 507: after receiving the application request information, the dual-stack server returns application data, and the whole service interaction is completed after the terminal receives the data from the server.

In a word, the technical solutions according to the embodiments of the present invention have the following advantages.

It is able to achieve free communication between IPv6 applications and the services of the other IP address families in an IPv4 network. During the transition from IPv4 to IPv6, various IP services will coexist in an IPv6 network, and these IP services are very important ways for the operators and Internet service providers to create more value, and very important resources for the user to improve the user experience. As a result, the communication between the IPv6 applications and the services of the other types in the IPv4 network will increase the service agility remarkably and improve the user experience.

In addition, according to the embodiments of the present invention, the burden of wireless air interfaces may be reduced. During the transition from IPv4 to IPv6, the IP header will be increased to 60 bytes due to the IP-in-IP tunneling technology. For a mobile network operator, wireless air interfaces are valuable and scarce resources, and hundreds of millions of mobile terminals will increase the network traffic load considerably. Moreover, the tunneling technology must be set up and maintained prior to the data communication, so it is expensive. According to the embodiments of the present invention, it is able to avoid excessive consumption of air interface resources and reduce the cost for maintenance during the transition from IPv4 to IPv6.

In addition, according to the embodiments of the present invention, direct communication can be supported between the hosts, and as a result, network single-point failure and bottleneck will be prevented.

Based on the same concept, the present invention further provides a device for network communication as shown in FIG. 6, which comprises:

a translating module 11, configured to, when receiving IPv6 information from an IPv6 application, translate the IPv6 information into IPv4 information;

a transmitting module 12, configured to transmit an IPv6 application request carrying the IPv4 information; and

a receiving module 13, configured to receive an IPv6 application response corresponding to the IPv6 application request.

The IPv6 information from the IPv6 application includes a DNS request carrying an AAAA type, wherein

the translating module 11 is specifically configured to translate the DNS request carrying the AAAA type into a DNS request carrying an AAAA type and an A type,

the transmitting module 12 is specifically configured to transmit the DNS request carrying the AAAA type and the A type to a DNS server within an IPv4 network, and

the receiving module 13 is specifically configured to receive a DNS response returned from the DNS server in accordance with a server type of a correspondent node accessed by the IPv6 application.

In addition, the device further comprises a processing module 14, wherein

the receiving module 13 is specifically configured to receive a DNS response carrying an A type from the DNS server when the correspondent node accessed by the IPv6 application is an IPv4 server;

the processing module 14 is configured to translate the A type into an AAAA type, creates a mapping relationship from IPv4 to IPv6, and notify the IPv6 application of a DNS response carrying the translated AAAA type;

the receiving module 13 is specifically configured to receive a DNS response carrying an AAAA type from the DNS server when the correspondent node accessed by the IPv6 application is an IPv6 server; and

the processing module 14 is configured to initiate a DNS request carrying an A type and an AAAA type to an NAT46 gateway, receive a DNS response carrying an A type and an AAAA type from the NAT46 gateway, and notify the IPv6 application of a DNS response carrying an AAAA type.

The IPv6 information transmitted by the IPv6 application includes IPv6 application information, wherein

the translating module 11 is specifically configured to translate an IPv6 source address in the IPv6 application information into an IPv4 source address, and translate an IPv6 target address in the IPv6 application information into an IPv4 target address,

the transmitting module 12 is specifically configured to transmit the translated IPv6 application information to the NAT46 gateway when the correspondent node accessed by the IPv6 application is an IPv6 server, and transmits the translated IPv6 application to the IPv4 server when the correspondent node accessed by the IPv6 application is an IPv4 server, and

the receiving module 13 is specifically configured to receive service data corresponding to the IPv6 application information from the NAT46 gateway when the correspondent node accessed by the IPv6 application is an IPv6 server, and receive service data corresponding to the IPv6 application information from the IPv4 server when the correspondent node accessed by the IPv6 application is an IPv4 server.

The modules of the device according to the present invention may be integrated together, or may be deployed separately. The above-mentioned modules may be combined into one module, or may be further divided into a plurality of submodules.

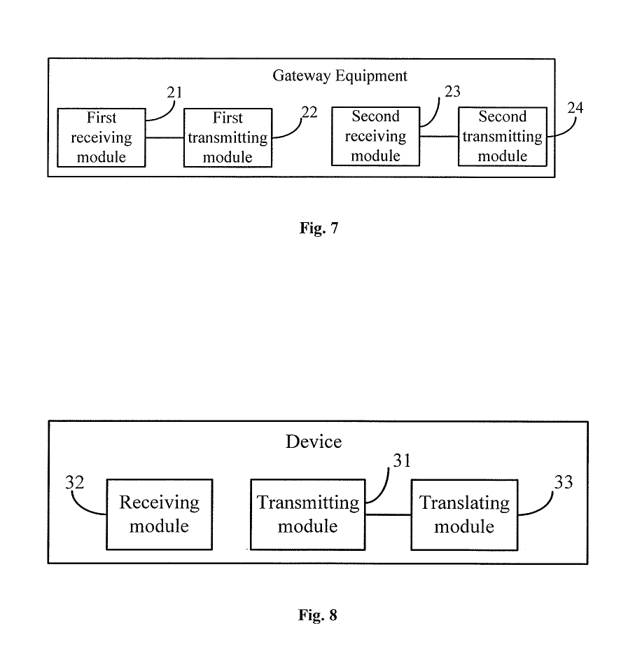

Based on the same concept, the present invention further provides a gateway equipment as shown in FIG. 7, which comprises:

a first receiving module 21, configured to receive a translated IPv4 request information from a terminal.

a first transmitting module 22, configured to transmit an IPv6 request corresponding to the IPv4 request information to a device within an IPv6 network;

a second receiving module 23, configured to receive an IPv6 response with respect to the IPv6 request corresponding to the IPv4 request information from the device within the IPv6 network; and

a second transmitting module 24, configured to transmit an IPv4 response corresponding to the IPv6 response to a terminal within an IPv4 network.

The IPv4 request information includes a DNS request carrying an AAAA type and an A type, wherein

the first receiving module 21 is specifically configured to receive a DNS request carrying an AAAA type and an A type from a terminal;

the first transmitting module 22 is specifically configured to transmit the DNS request carrying an AAAA type and an A type to a DNS server within the IPv6 network;

the second receiving module 23 is specifically configured to receive the DNS response carrying an AAAA type from a DNS server in the IPv6 network; and

the second transmitting module 24 is specifically configured to translate the AAAA type in the DNS response carrying an AAAA type into an A type and an AAAA type, create a mapping relationship from IPv6 to IPv4, and transmit a DNS response carrying an A type and an AAAA type to a terminal in the IPv4 network.

The IPv4 request information includes IPv6 application information carrying an IPv4 source address and an IPv4 target address, wherein

the first receiving module 21 is specifically configured to receive IPv6 application information carrying an IPv4 source address and an IPv4 target address from a terminal,

the first transmitting module 22 is specifically configured to translate the IPv4 source address in the IPv6 application information into an IPv6 source address and translate the IPv4 target address in the IPv6 application information into an IPv6 target address in accordance with the mapping relationship from IPv6 to IPv4, and transmit IPv6 application information carrying the IPv6 source address and the IPv6 target address to an IPv6 server within the IPv6 network,

the second receiving module 23 is specifically configured to receive service data corresponding to the IPv6 application information from the IPv6 server within the IPv6 network, and

the second transmitting module 24 is specifically configured to translate an IPv6 source address in the service data into an IPv4 source address and translate an IPv6 target address in the service data into an IPv4 target address in accordance with the mapping relationship from IPv6 to IPv4, and transmit the service data carrying the IPv4 source address and the IPv4 target address to a terminal within the IPv4 network.

The modules of the device according to the present invention may be integrated together, or may be deployed separately. The above-mentioned modules may be combined into one module, or may be further divided into a plurality of submodules.

Based on the same concept, the present invention further provides a device for network communication as shown in FIG. 8, which comprises:

a transmitting module 31 configured to, when receiving IPv6 application information, transmit the IPv6 application information to a dual-stack server;

a receiving module 32 configured to receive service data corresponding to the IPv6 application information from the dual-stack server; and a translating module 33 configured to, when the IPv6 application transmits a DNS request carrying an AAAA type, translate the AAAA type to an AAAA type and an A type.

The transmitting module 31 is further configured to transmit a DNS request carrying an AAAA type and an A type to a DNS server within an IPv4 network; and

the receiving module 32 is further configured to receive a DNS response carrying an A type and an AAAA type from the DNS server, and notify the IPv6 application of the DNS response carrying an AAAA type.

The modules of the device according to the present invention may be integrated together, or may be deployed separately. The above-mentioned modules may be combined into one module, or may be further divided into a plurality of submodules.

Through the above-mentioned description, it may be apparent for a person skilled in the art that the present invention may be implemented by hardware, or by software as well as a necessary common hardware platform. Based on this understanding, the technical solutions of the present invention may appear in the form of software products, which may be stored in a non-volatile storage medium (CD-ROM, USB flash disk or mobile HDD) and may include several instructions so as to enable a computer equipment (personal computer, server or network equipment) to execute the methods according to the embodiments of the present invention.

A person skilled in the art may appreciate that the drawings merely relate to the preferred embodiments, and the modules or flows in the drawings are not always necessary for the implementation of the present invention.

A person skilled in the art may further appreciate that the modules in the device may be arranged in the device as described in the embodiments or, after some changes, in one or more devices different from that according to the embodiments of the present invention. The modules may be combined into one module, or may be further divided into a plurality of submodules.

The number of the embodiments is for illustrative only, and none of them is superior to the others.

The above are merely several embodiments of the present invention, but the present invention is not limited to them. A person skilled in the art may make alterations thereto, which shall also fall within the scope of the present invention.

1-19. (canceled)

20. A method for network communication, wherein comprising the steps of:
translating, by a terminal, IPv6 information into IPv4 information when receiving the IPv6 information from an IPv6 application, and transmitting an IPv6 application request carrying the IPv4 information; and
receiving, by the terminal, an IPv6 application response corresponding to the IPv6 application request;
wherein the IPv6 information from the IPv6 application includes a DNS request carrying an AAAA type, and
wherein the step of translating, by a terminal, IPv6 information into IPv4 information comprises:
translating, by the terminal, the DNS request carrying an AAAA type into a DNS request carrying an AAAA type and an A type;
wherein the step of transmitting an IPv6 application request carrying the IPv4 information comprises:
transmitting, by a terminal, the DNS request carrying an AAAA type and an A type to a DNS server within an IPv4 network, and
wherein the step of receiving, by the terminal, an IPv6 application response corresponding to the IPv6 application request comprises:
receiving, by the terminal, a DNS response returned from the DNS server in accordance with a server type of a correspondent node accessed by the IPv6 application.

21. The method according to claim 20, wherein when the correspondent node accessed by the IPv6 application is an IPv4 server, the step of receiving, by the terminal, a DNS response returned from the DNS server in accordance with a server type of a correspondent node accessed by the IPv6 application comprises:
receiving, by the terminal, a DNS response carrying an A type returned from the DNS server,
wherein after receiving, by the terminal, a DNS response returned from the DNS server in accordance with a server type of a correspondent node accessed by the IPv6 application, the method further comprises:
translating, by the terminal, an A type into an AAAA type, creating a mapping relationship from IPv4 to IPv6, and notifying the IPv6 application of the DNS response carrying an AAAA type;
wherein when the correspondent node accessed by the IPv6 application is an IPv6 server, the step of receiving, by the terminal, a DNS response returned from the DNS server in accordance with a server type of a correspondent node accessed by the IPv6 application comprises:
receiving, by the terminal, a DNS response carrying an AAAA type returned from the DNS server,
and wherein after receiving, by the terminal, a DNS response returned from the DNS server in accordance with a server type of a correspondent node accessed by the IPv6 application, the method further comprises:
initiating, by the terminal, a DNS request carrying an A type and an AAAA type toward an NAT46 gateway, receiving a DNS response carrying an A type and an AAAA type returned from the NAT46 gateway, and notifying the IPv6 application of the DNS response carrying an AAAA type.

22. The method according to claim 21, wherein after the terminal initiates a DNS request carrying an A type and an AAAA type toward the NAT46 gateway, the method further comprises:
transmitting, by the NAT46 gateway, the DNS request carrying an A type and an AAAA type to a DNS server within an IPv6 network;
transmitting, by the DNS server within the IPv6 network, a DNS response carrying an AAAA type toward the NAT46 gateway;
resolving, by the NAT46 gateway, an AAAA type to an A type and an AAAA type, and creating a mapping relationship from IPv6 to IPv4; and
transmitting, by the NAT46 gateway, a DNS response carrying the resolved A type and AAAA type to the terminal.

23. The method according to claim 20, wherein the IPv6 information from the IPv6 application includes IPv6 application information,
and wherein the step of translating, by a terminal, IPv6 information into IPv4 information comprises:
translating, by the terminal, an IPv6 source address in the IPv6 application information into an IPv4 source address, and translating an IPv6 target address in the IPv6 application information into an IPv4 target address.

24. The method according to claim 23, wherein when the correspondent node accessed by the IPv6 application is an IPv6 server,
the step of transmitting an IPv6 application request carrying the IPv4 information comprises: transmitting, by the terminal, the translated IPv6 application information to the NAT46 gateway,
the step of receiving, by the terminal, an IPv6 application response corresponding to the IPv6 application request comprises: receiving, by the terminal, service data corresponding to the IPv6 application information returned from the NAT46 gateway,
and wherein when the correspondent node accessed by the IPv6 application is an IPv4 server,
the step of transmitting an IPv6 application request carrying the IPv4 information comprises: transmitting, by the terminal, the translated IPv6 application information to the IPv4 server, and
the step of receiving, by the terminal, an IPv6 application response corresponding to the IPv6 application request comprises: receiving, by the terminal, service data corresponding to the IPv6 application information returned from the IPv4 server.

25. The method according to claim 24, wherein prior to receiving, by the terminal, service data corresponding to the IPv6 application information returned from the NAT46 gateway, the method further comprises:
when receiving the translated IPv6 application information, translating, by the NAT46 gateway, an IPv4 source address in the translated IPv6 application information into an IPv6 source address and translating an IPv4 target address in the translated IPv6 application information into an IPv6 target address in accordance with the mapping relationship from IPv6 to IPv4;
transmitting, by the NAT46 gateway, the IPv6 application information carrying the IPv6 source address and the IPv6 target address to an IPv6 server, and returning, by the IPv6 server, service data corresponding to the IPv6 application information;
translating, by the NAT46 gateway, an IPv6 source address in the service data into an IPv4 source address and translating an IPv6 target address in the service data into an IPv4 target address in accordance with the mapping relationship from IPv6 to IPv4; and
transmitting, by the NAT46 gateway, service data corresponding to the translated IPv6 application information to the terminal.

26. A device for network communication, wherein comprising:
a translating module, configured to translate IPv6 information into IPv4 information when receiving the IPv6 information from an IPv6 application;
a transmitting module, configured to transmit an IPv6 application request carrying the IPv4 information; and
a receiving module, configured to receive an IPv6 application response corresponding to the IPv6 application request;
wherein the IPv6 information from the IPv6 application includes a DNS request carrying an AAAA type,
the translating module is specifically configured to translate the DNS request carrying an AAAA type into a DNS request carrying an AAAA type and an A type,
the transmitting module is specifically configured to transmit the DNS request carrying an AAAA type and an A type to a DNS server within an IPv4 network, and
the receiving module is specifically configured to receive a DNS response returned from the DNS server in accordance with a server type of a correspondent node accessed by the IPv6 application.

27. The device according to claim 26, wherein further comprising a processing module,
wherein the receiving module is specifically configured to receive a DNS response carrying an A type from the DNS server when the correspondent node accessed by the IPv6 application is an IPv4 server,
the processing module is configured to translate an A type into an AAAA type, create a mapping relationship from IPv4 to IPv6, and notify the IPv6 application of a DNS response carrying the translated AAAA type,
the receiving module is specifically configured to receive a DNS response carrying an AAAA type from the DNS server when the correspondent node accessed by the IPv6 application is an IPv6 server, and
the processing module is configured to initiate a DNS request carrying an A type and an AAAA type to an NAT46 gateway, receive a DNS response carrying an A type and an AAAA type from an NAT46 gateway, and notify the IPv6 application of a DNS response carrying an AAAA type.

28. The device according to claim 26, wherein the IPv6 information from the IPv6 application includes IPv6 application information,
the translating module is specifically configured to translate an IPv6 source address in the IPv6 application information into an IPv4 source address, and translate an IPv6 target address in the IPv6 application information into an IPv4 target address,
the transmitting module is specifically configured to transmit the translated IPv6 application information to an NAT46 gateway when the correspondent node accessed by the IPv6 application is an IPv6 server, and transmits the translated IPv6 application to the IPv4 server when the correspondent node accessed by the IPv6 application is an IPv4 server, and
the receiving module is specifically configured to receive service data corresponding to the IPv6 application information from the NAT46 gateway when the correspondent node accessed by the IPv6 application is an IPv6 server, and receive service data corresponding to the IPv6 application information from the IPv4 server when the correspondent node accessed by the IPv6 application is an IPv4 server.

29. A gateway equipment, wherein comprising:
a first receiving module configured to receive a translated IPv4 request information from a terminal;
a first transmitting module configured to transmit an IPv6 request corresponding to the IPv4 request information to a device in an IPv6 network;
a second receiving module configured to receive an IPv6 response from the device in the IPv6 network with respect to the IPv6 request corresponding to the IPv4 request information; and
a second transmitting module configured to transmit an IPv4 response corresponding to the IPv6 response to a device in an IPv4 network;
wherein the IPv4 request information includes a DNS request carrying an AAAA type and an A type,
the first receiving module is specifically configured to receive a DNS request carrying an AAAA type and an A type from a terminal,
the first transmitting module is specifically configured to transmit the DNS request carrying an AAAA type and an A type to a DNS server within the IPv6 network,
the second receiving module is specifically configured to receive a DNS response carrying an AAAA type from a DNS server in the IPv6 network, and the second transmitting module is specifically configured to translate an AAAA type in the DNS response carrying an AAAA type into an A type and an AAAA type, create a mapping relationship from IPv6 to IPv4, and transmit a DNS response carrying an A type and an AAAA type to a terminal in the IPv4 network.

30. The gateway equipment according to claim 29, wherein the IPv4 request information includes IPv6 application information carrying an IPv4 source address and an IPv4 target address,
the first receiving module is specifically configured to receive the IPv6 application information carrying an IPv4 source address and an IPv4 target address from a terminal,
the first transmitting module is specifically configured to translate the IPv4 source address in the IPv6 application information into an IPv6 source address and translate the IPv4 target address in the IPv6 application information into an IPv6 target address in accordance with the mapping relationship from IPv6 to IPv4, and transmit IPv6 application information carrying the IPv6 source address and the IPv6 target address to an IPv6 server within the IPv6 network,
the second receiving module is specifically configured to receive service data corresponding to the IPv6 application information from the IPv6 server within the IPv6 network, and
the second transmitting module is specifically configured to translate an IPv6 source address in the service data into an IPv4 source address and translate an IPv6 target address in the service data into an IPv4 target address in accordance with the mapping relationship from IPv6 to IPv4, and transmit the service data carrying the IPv4 source address and the IPv4 target address to a terminal within the IPv4 network.
